(19) United States
(12) Patent Application Publication
(10) Pub. No.: US 2009/0319172 A1
(43) Pub. Date: Dec. 24, 2009

(54) TRAVEL TIME PREDICTION SYSTEM

(75) Inventors: Paulo Arrais Dimas Almeida, Lisboa (PT); Miguel Filipe Dos Santos, Lisboa (PT); Sampo Tapani Kellomaki, Lisboa (PT)

Correspondence Address: FISH & RICHARDSON P.C., P.O BOX 1022, Minneapolis, MN, 55440-1022, US

(73) Assignee: TimeBi, Lda, 1400 Lisboa (PT)

(21) Appl. No.: 12/110,189

(22) Filed: Apr. 25, 2008

Related U.S. Application Data
(60) Provisional application No. 60/914,278, filed on Apr. 26, 2007.

(51) Int. Cl. G01C 21/00; G06F 21/00

(52) U.S. Cl. 701/201; 701/200; 726/4

(57) ABSTRACT

Networked travel time prediction systems and methods are disclosed. Users on the system may share location, travel time, destination, and location information with their peers. Travel time predictions may be calculated using historical route information, which may be weighted based on various characteristics thereof. Time fences are taught defined by a fixed travel time, for example. Prediction request methods are taught using, for example, formatted requests, identity providers, privacy assertions, geo-location servers, and time prediction servers.

### RELATED APPLICATIONS

This application claims the benefit of priority of U.S. Provisional Application No. 60/914,278, filed Apr. 26, 2007, the entire contents of which are hereby incorporated herein by reference.

### TECHNICAL FIELD

This invention relates to systems and methods to predict, share, or use travel time prediction or other travel or location information, including among users.

### BACKGROUND

Various calculations, systems, and methods exist to predict travel time based on a traveler's route and various route speed information. Some systems provide travelers notification when they are within a certain geographic or travel distance to their destination or other point of interest. Some of these systems may be employed on mobile phones or portable computing devices.

What is needed, however, are travel time systems to increase efficiency by any of among other advances, reducing travel time, decreasing the number of inquires needed to update travel time predictions, applying information from a social network, applying information from historic sources, to share, make, or use travel time predications. What is also needed are notification systems to inform users. What is further needed are systems to integrate such predications and notifications with mobile devices having geography or location systems, such as Global Positioning Satellite (GPS) or related systems. Application of the system and improvements in travel time prediction mean net gains in the utility and effectiveness of information for users or peers. Application of the system and improvements in travel time prediction mean more efficient and rapid detection of anomalies, including traffic conditions, other real time conditions, and dissemination to peers.

### SUMMARY

Networked travel time prediction systems and methods are disclosed. In one embodiment, networked travel time prediction systems or methods are preferably provided by a web-based or web-related service or system. Users on the system may share location, travel time, destination, location, or other location, time, destination, or related information with their peers. Travel time predictions may be calculated using historical route information, which may be weighted based on various characteristics thereof. In one embodiment, time fences, including travel time-bounded perimeters around a location, are taught defined by a fixed travel time, for example. In another embodiment, prediction request methods are taught using, for example, formatted requests, identity providers, privacy assertions, geo-location servers, or time prediction servers.

The details of one or more embodiments of the invention are set forth in the accompanying text, the figures, and the descriptions below. Other features, objects, or advantages will be apparent from the text, description, and drawings, and from the claims.

### BRIEF DESCRIPTION OF DRAWINGS

FIG. 1 is an architectural diagram of a networked travel time prediction system.

FIG. 2 is a block diagram of a networked travel time prediction system client software interface.

FIG. 3 is a flow chart of a travel time prediction scheme according to one embodiment.

FIG. 4 is a flow chart of another travel time prediction scheme according to another embodiment.

FIG. 5 is a flow chart of another travel time prediction scheme according to yet another embodiment.

FIG. 6 is a screenshot of selecting peers in a travel time prediction application.

FIG. 7 is a screenshot of displaying travel time in a travel time prediction application.

FIG. 8 is a screenshot of a displaying a map in a travel time prediction application.

FIG. 9 is a screenshot of locations in a travel time prediction application.

FIG. 10 is a screenshot of sharing a location in a travel time prediction application.

FIG. 11 is a screenshot of peer movement information in a travel time prediction application.

FIG. 12 is a screenshot of selecting a route in a travel time prediction application.

FIG. 13 is a flow chart of a travel time prediction social networking scheme according to one embodiment.

FIG. 14 is a flow chart of a travel time prediction social networking scheme according to another embodiment.

Like reference symbols in the various drawings typically represent like elements.

### DETAILED DESCRIPTION

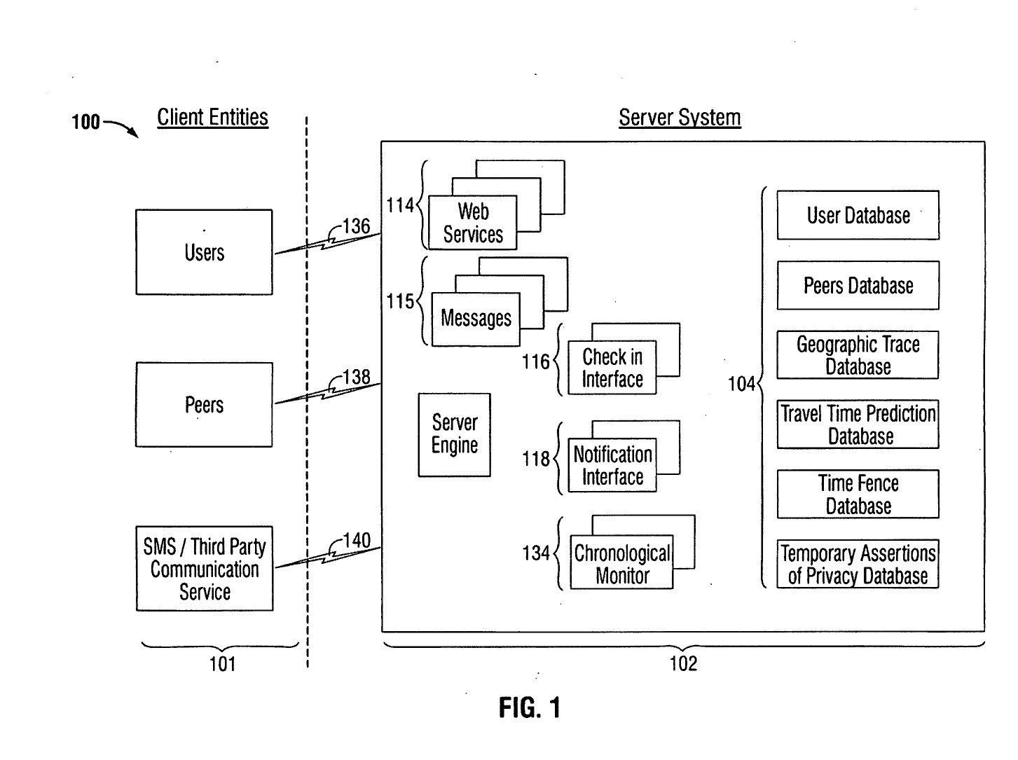

FIG. 1 is a block diagram representation of a networked travel time prediction system 100 according to one embodiment. In the depicted system 100, travel times for clients 101 are predicted and shared by system 100. A travel time can be predicting using a number of factors. For example, the distance to a location, traffic volume, road construction, weather conditions, and accidents can impact travel time. The system 100 may utilize information provided by users of the system to automatically provide information, in real time, that is subsequently used to improve the accuracy of the travel time predictions. As an emergent property of using such historical travel data, the prediction accuracy for a certain group of travelers can improve and may improve by spatial region (e.g., a neighborhood) for regions and routes that are typically traveled by that peer group. The improved accuracy in spatial regions can benefit groups of people that are socially connected (e.g., people in a “friends” network, or people in an address book, and the like) because they tend to go to the same places and to follow the same routes within a city. For example, a family or a group of coworkers typically follows many of the same routes. The system collects anonymous historical data based on this travel, and is able to provide more accurate predictions for the peer group, and other users in the area, based on that data.

The travel time prediction system 100 may use client-to-server communication, peer-to-peer communication, or combinations thereof to determine and disseminate travel time predictions. Because of this, and for other reasons, the travel time prediction system 100 includes client units 101 and a server system 102. The server system 102 communicates with client units 101, which may include cell phones, personal digital assistants (PDAs), handheld computers, or other digital devices. Any number of client units 101 can communicate with the server system 102. The client units 101 include a travel time prediction application. The travel time prediction application may include a user interface to provide information corresponding to estimated time of arrival (ETA), accuracy metrics related to the ETA, fastest route to a specified location, and information corresponding to other users (e.g., locations of other users, ETAs of other users, and the like), to name a few examples. In some implementations, other user information is provided only after security credentials are provided to and verified by the server system 102.

Preferably, client units users 106 or peers 108 are provided with global positioning system (GPS) geo-location receivers, which are configured to operate with the installed travel time prediction client application. Preferably, client units 101 communicate over an IP network connected to the Internet. In other embodiments, other IP networks or other types of networks may be employed, such as, for example, cellular phone data networks or mobile broadband data networks. Peer-to-peer location information is provided by GPS typically but also for shorter ranges with shorter range communications, including for example through a wireless wide area network (WAN), wireless metropolitan area network (MAN), or other short range communication systems or techniques.

To facilitate predictions, the client units 101 may upload locations to the server system 102. In some implementations, locations are uploaded by the client units 101 in continuous time intervals. The continuously uploaded time intervals can generate geographic traces. These traces can be used implicitly to suggest routes among the client units 101. For example, consider a user A and a user B. User A is traveling to a predetermined location (e.g., a park, an office, a residence, or the like) without knowing a preferred travel route. However, user B had previously traversed a path from user A's location to the desired destination. In this case, and other similar cases, the server system 102 can present, by way of a suggested route, user's B path previously traversed path to user A as a suggested path.

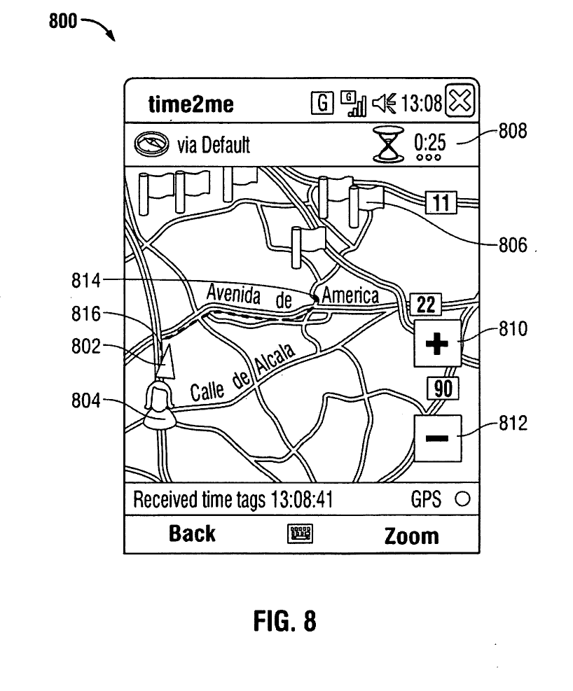

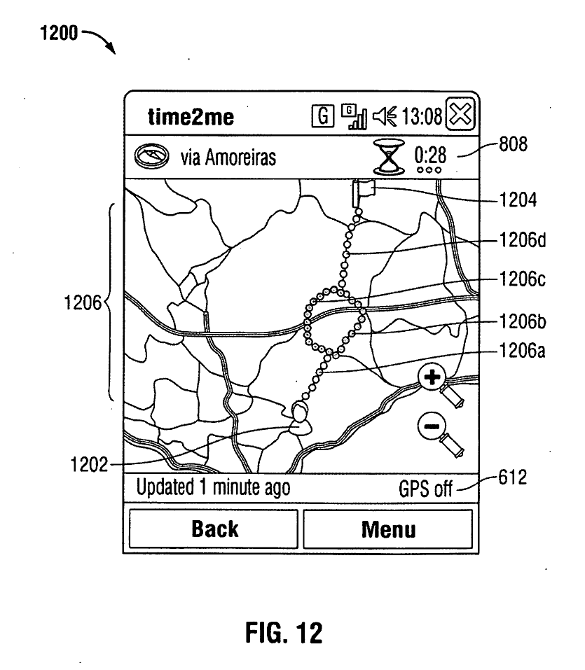

In addition, any suggestion can be provided in real time to recommend the fastest routes as conditions change. Suppose, for example, while another user (e.g., user C), attempts to travel to the same destination as user A, however, while user A is traveling, a car accident occurs. Because user A's client is continuously uploading location information, the server system 102 can determine that user A's current route is not the fastest, and that other faster routes exist. Any of these faster routes can be presented as an updated suggestion to user C. In some implementations, different routes may be represented graphically using vectors or different colors on a map, to name two examples. The vectors or colors may be used to represent different average travel times, thus providing the user with an intuitive visual representation of the suggested routes. Graphical representations are described in more detail in reference to FIGS. 8 and 12.

Because, for example, a client unit 101 may be in continuous communication with the server system 102, the travel time prediction system 100 can avoid the use of other external data collection devices and techniques, such as video cameras, road sensors, aerial surveillance, and the like.

In one implementation, the client unit 101 may utilize a GPS economy mode. The GPS economy mode may utilize the network IDs broadcast from cell towers to enable or disable the GPS on the client device. For example, receiving the same ID for a certain time period predicts that the device location will not change significantly in the near future thus the GPS can be turned off. As another example, detecting changes in the ID implies potential movement of the device necessitating the device to turn on the GPS to obtain location information.

The server system 102 generally hosts the web-service-based travel time prediction system 100 for creating, managing, or delivering travel time prediction messages for multiple personal travel time prediction clients. The server system 102 includes one or more computers operable to receive, transmit, process, and store data associated with travel network architecture 100. Although FIG. 1 illustrates one server system 102 that may be used with the disclosure, the architecture 100 may be implemented using computers other than servers, as well as a server pool. The server system 102 may be any computer or processing device, such as, for example, a blade server, one or more general-purpose personal computer (PC), one or more Apple Macintosh computers, a workstation, one or more Unix-based computer, or any other suitable device or suitable devices. According to one implementation, the server system 102 may also include or be communicably coupled with a server engine 112 or a mail server or both. As shown in FIG. 1, a server system 102 may include a server engine 112 for serving web pages to client devices across the Internet or an intranet.

The server engine 112 generally hosts and processes data 114, which may include messages 1115 that can be associated with the networked travel time prediction system 100. In some implementations, the messages 115 are extensible markup language (XML) formatted messages. Messages may be sent or received, to or from, various user client applications by a simple object access protocol (SOAP). Typically, SOAP utilizes hypertext transfer protocol (HTTP) to transmit messages. For example, the server engine 112 can serve the XML formatted information using a protocol such as HTTP, or any other suitable protocol that may effectively transmit data items. Other server architectures may be used, for example a Microsoft.NET architecture or a proprietary service architecture run on a network such as a cellular phone network. In addition, the server engine 112 can process security credentials submitted by client units 101. The security credentials may specify which users are allowed to access other user information, at a particular time, or for a particular purpose. For example, a user A can specify that a user B can view user A's current location, destination, ETA information, or combinations thereof. Moreover, user A may additionally be able to deny a user C the ability to view current location, destination, ETA information, or combinations thereof.

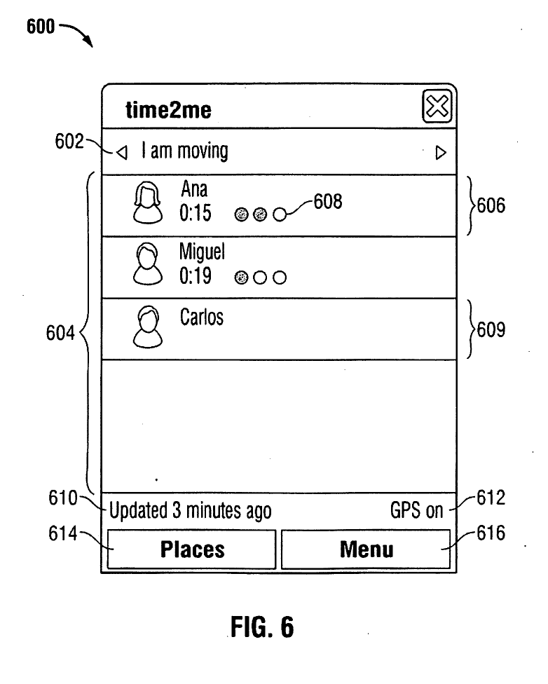

In general the system 102 presents a user access to system features through web services 114. A client may enter contact data, location data, and notification or check-in data in the various depicted database tables 122-132 (such as a user database or a peer database). Examples of entering data are described in more detail in reference to FIGS. 6-12. After the server system 102 generates travel time predictions or other information, the information can be transmitted to the client units 101 for display. For example, server system 102 can generate an XML formatted message describing one or more values corresponding to location, ETA, ETA accuracy, or other information for all users in the server system 102 and transmit any of that information to one or more client units 101 using SOAP. The client units 101 that receive information, unusually a message, can then parse the message and use data contained therein to populate an ETA field of a user interface or a graphical representation of a suggested route, to name a few examples. In some implementations, the message is encrypted and must be decrypted (e.g., by using a cryptographic key) before the information can be accessed. Methods and techniques for encryption and decryption are well known in the art.

In particular, the depicted system employs one or more databases 104 to house user data. The depicted database tables 122-132 may be tables or separate databases, or in some instances may be combined within a table. For example, one or more user group or peer group may be stored in the same table as peer designations. Therefore, while a “database” is described with regard to FIG. 1, various data structures and tables may be used. The user database or table 122 can store user accounts (e.g., personal travel time prediction system accounts) as well as user preferences. Similarly, the peer to peer database or table 124 can store contact information as well as contact preferences related to the users stored in the user database or table 122. This table or another table may store geographic traces indicating a user's movement along their travel path. In addition, table 122 or 124 can include data corresponding to security preferences. For example, table 122 can include user A's specified permissions for the other users (e.g., user B or user C or both or more) that can display user A's location, ETA, and the like on user B and user C's client units 101 respectively.

The geographic database or table 126 may store geographically specific information regarding local traffic conditions, travel times, and users. In addition, the primary contacts database or table 126 can be used as a mechanism to segregate travel time predictions (e.g., to send a travel time prediction message only to peers).

The travel time predictions database or table 128 may store active user-defined travel time prediction requests, with their respective designated set of peers to receive and share the travel time predictions. Travel time predictions may be configured with notifications to the user explaining that an arrival is imminent. The travel time predictions database or table 128 can store pending travel time predictions, new travel time predictions, and active travel time predictions, as well as previously configured travel time predictions.

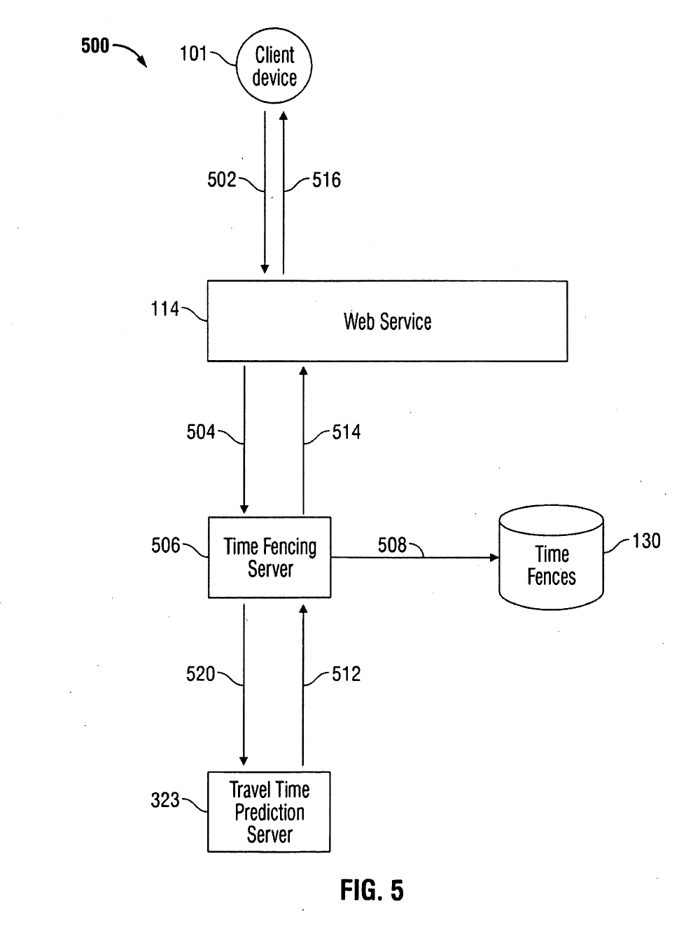

The time fence database or table 130 may store information used to generate a time fence. The time fence database or table 130 may be used to send notifications corresponding to when a user enters any particular time fence, leaves the time fence, or reaches, the center of the time fence, to name a few examples. A time fence may be represented as a data defining shape on a map, typically asymmetrical, that specifies the approximate distance traveled in a specific time frame in all directions. In other words, a time fence can be generated using a specified time frame and calculating an approximate distance in all directions based on current travel conditions, such as traffic and weather conditions. Generating time fences and time fence notifications are described in more detail in reference to FIG. 5.

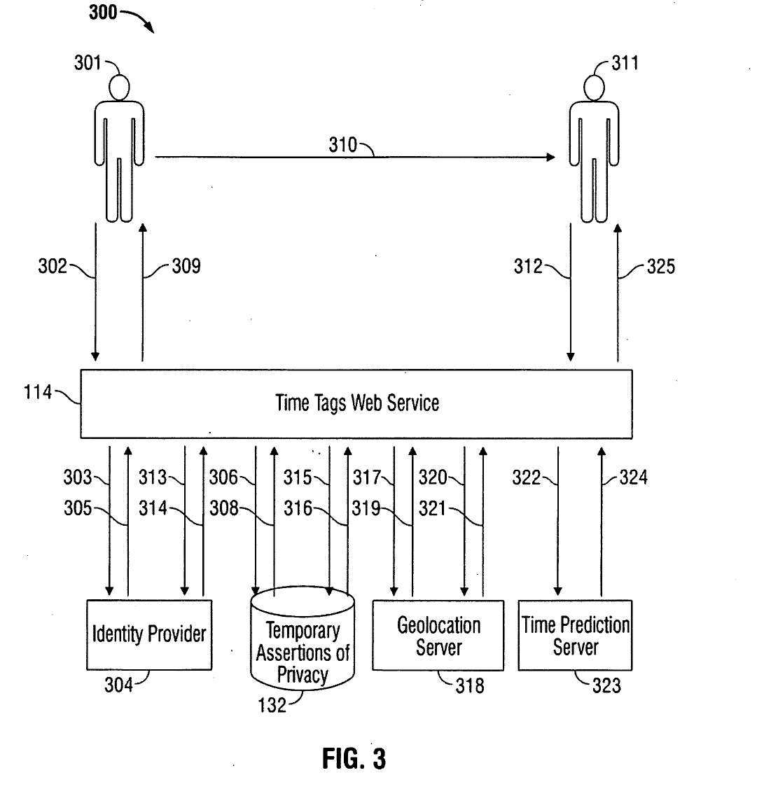

The temporary assertions of privacy database 132 can provide security information that can be used to determine the view permissions of users, or peers, or both. For example, the temporary assertions privacy database 132 can provide security information corresponding to view permissions for a user's home location, current geo-location, or any other location defined by a user. In one implementation, pseudonyms for both a user's identity and a user's location can be generated according to the security information. Pseudonyms for locations are provided to further enhance the security provided by using a pseudonym for a particular user. For example, consider a situation where user A is at their residence. Without a pseudonym corresponding to the user's residence, a correlation between the user's pseudonym and their respective residence may expose their identity to other users. The pseudonyms can be generated randomly, or through other conventional pseudonym generating techniques. The temporary assertion of privacy database 132 is described in more detail in reference to FIG. 3.

A server system 102 depicted in FIG. 1 further includes a chronological monitor 134. System 102 may employ the chronological monitor 134 to monitor travel time predictions that are activated. Chronological monitor 134 (“cron job 134”) preferably implements travel time prediction notifications by scheduling travel time predictions and travel time arrival notifications as a standard cron job. This may occur within the travel time predictions database or a separate cron job database.

The server system 102 may also include control interfaces, such as a manual check-in/arrival notice interface 116 and a notification interface 118. For example, the user may access the server system 102 to disable a travel time prediction or enable a travel time prediction. The check-in interface 116 can process the check-in event and implement requested notification tasks, for example. The notification interface 118 can handle how travel time prediction messages are sent, for example to peers. For example, notification may be handled through email, or on-screen messages, or audible signals (e.g., specialized ring-tones), or the like.

The server system 102 may often include local electronic storage capacity, such as data repositories. The data repositories may include any memory or database module and may take the form of volatile or non-volatile memory including, without limitation, magnetic media, optical media, random access memory (RAM), read-only memory (ROM), removable media, or any other suitable local or remote memory component. An illustrated database or databases, such as any of databases 104 may store system data such as message data, travel time prediction data, VPN applications or services, firewall policies, a security or access log, print or other reporting files, HTML files or templates, data classes or object interfaces, software applications or sub-systems, not shown or others.

In some embodiments, the server 102 may utilize a restricted computer network, such as a private network created using World Wide Web software, or a public network, such as the Internet. Regardless of the type of computer network utilized, the network (represented abstractly by 136, 138, and 140) facilitates wireless or wireline communication between the server system 102, users 106, peers 108, third party services 110, and any other local or remote computers, wireless devices, or telephone lines using the networked travel time prediction system 100. In a preferred embodiment, the network is the Internet. The network may also be all or a portion of an enterprise or secured network or on a private intranet. In another example, the network may be a virtual private network (VPN) between the clients 101 and the server system 102 across a wireline or a wireless link. In certain implementations, the network may be a secure network associated with the enterprise and certain local or remote clients.

Regardless of the particular hardware or software architecture used, the networked travel time prediction system 100 can be used to create, manage, and deliver travel time predictions for a personal travel time prediction system. The following descriptions of methods and screen shots focus on the operation of different implementations of an networked travel time prediction system 100, or one of its components or sub-modules, in performing one of the respective methods or processes. However, the architecture 100 contemplates using any appropriate combination and arrangement of logical elements implementing some or all of the described functionality.

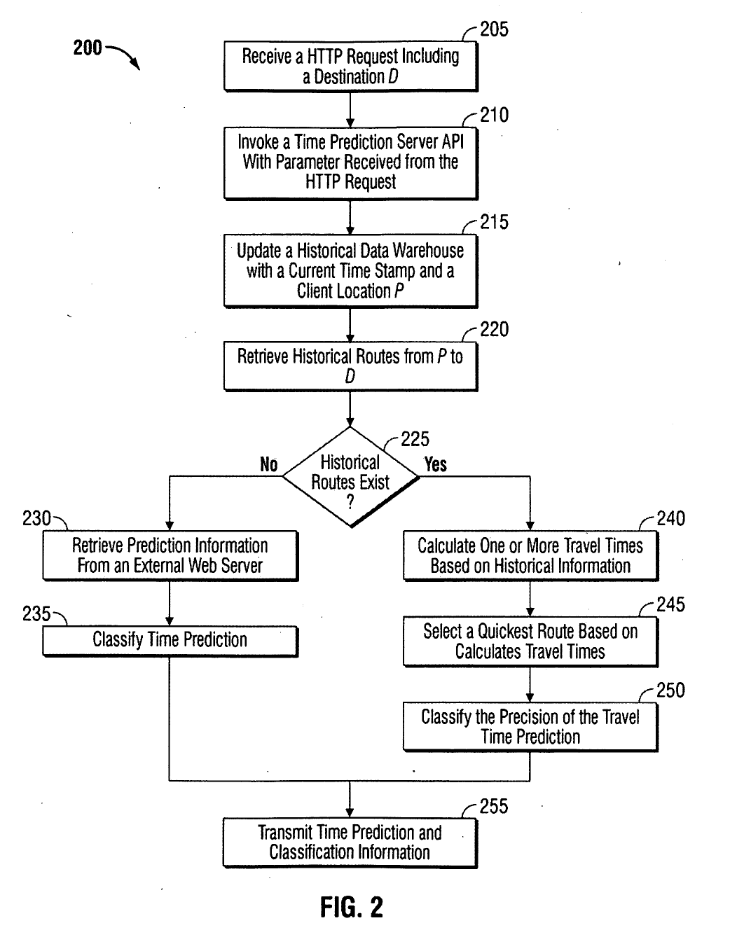

FIG. 2 is a flow chart of a travel time prediction scenario 200 according to one embodiment. In step 205, a request is received, typically a user request, preferably via HTTP. For example, web services 104 can receive an HTTP request over the Internet using the SOAP protocol. In some implementations, the received HTTP request can be generated when a user selects a destination in a travel time prediction application running on client units 101, for example. Generated in this fashion, the HTTP request can include client information, such as a destination ID, for example. The destination ID may specify a location that a user wishes to travel to. For example, the location ID can specify a location D as a destination location.

In step 210, the web service invokes a time prediction server (TPS) application program interface (API) with the received parameters. In step 215, the time prediction server updates a historical data warehouse (HDW) with a current timestamp, and a client location P, for example. In step 220, the TPS retrieves historical routes that go from location P to location D. For example, server system 102 can reference information located in table 126, table 128, or both, to determine if a historical route exists between locations P and D.

In step 225, the server system 102 may check if there are any historical routes. If there are no acceptable historical routes, then in step 230, the server system 102 typically may retrieve time prediction information from an external web server. For example, server system 102 may access a website on the Internet and use the travel time provided by the website. Example websites include, but are not limited to, MapPoint from Microsoft (Redmond, Wash.), MapQuest from American Online (Dulles, Va.), Google Maps from Google (Mountain View, Calif.), and Yahoo! Maps from Yahoo! (Sunnyvale, Calif.). In step 235, the time prediction received from the website is classified as a static time prediction. In other words, a time prediction may be generated or updated without the aid of constantly updated historical or real-time information.

Otherwise, if there are one or more historical routes, in step 240, one or more travel times are calculated for the historical routes. In some implementations, the travel time is calculated by subdividing the one or more routes into portions. The travel time for each portion can then be determined by using one or more times for the portion in the HDW and the total time calculated by summing the portions together. Moreover, in some implementations, the travel times stored in the HDW can be weighted using one or more weights including real time weights, time of day weights, day of the week weights, month weights, weather weights, holidays, weather conditions, or events weights. Both the weighted and un-weighted values, among others, can be stored in the one or more databases 104, for example.

The better use of information to weight routes increases the value and the efficiency of the travel time prediction social network system. The choice of a route can be weighted input from social peers, route information found in one or more historical database, routes obtained from other outside sources, information generated from known algorithms, and travel time predictions, whether those travel time predictions are based on information from social peers, historical information, external travel time estimates, or algorithms. Information can be stored in a database, and accessed from a database, such as any of databases 104.

Information for weighting can be used to optimize a route choice. The optimization may be based on minimization of travel time, or congestion, density, or other information. Optimization may be based also on the predicted or expected reliability of estimates, the prediction or chance of disruption, choices made by peers, or other methods known to the art.

In one embodiment, optimization includes seeding any chosen algorithm with route candidate information generated by peers. The use of information from peers can allow an algorithm to converge more quickly that when an algorithm does not use information for peers. The use of information from peers leverages the commonality of behavior as information to make more efficient the production of a travel time computation. As one example, location data generated, in real time by peers or other users can be detected anomalies such as construction, traffic, congestion, or other unexpected or unusual condition. Results and intermediate results can be cached.

In general, a real time weighting applies a higher weight if a travel time in the HDW is current. For example, if there is a travel time in the HDW within the last five minutes, that value is typically weighted more heavily than if the travel time in the HDW is from five hours ago. A time-of-day weighting can apply a higher weight if a travel time in the HDW occurred during the same time. For example, if there is a travel time in the HDW at or substantially near the current time of the prediction request, that value is typically weighted more heavily than if the travel time in the HDW is from a substantially different time period. A day of the week weighting can apply a higher weight if a travel time in the HDW occurred during the same day of the week. For example, if there is a travel time in the HDW from the same day, that value is typically weighted more heavily than if the travel time in the HDW is from four days past. A month weighting can apply a higher weight if a travel time occurs in the same month. A weather weighting can apply a higher weight if the weather conditions are substantially similar. For example, consider travel during a rain storm, travel times associated with rain are weighted higher than travel times during clear weather or snow. An event weighting can apply a higher weight if the travel time occurs when substantially similar local events occurred. For example, a higher weight can be applied if travel occurs at the same time as a sporting event, a concert, a parade, or some other event occurs during the travel period.

In a preferred embodiment, the weights are employed to rank the various historical times for selection, and a highest rank is chosen. Other types of weighting methods exist and may be employed with the weights discussed above, suitably normalized. For example, some systems provide a weighting scheme that combines historical times with various weights. In some such systems, the time estimate calculation includes a real-time estimate based on current speed information. (For example, see U.S. Pat. No. 6,317,686, discussed below, which teaches a travel time calculation weighing historical data with a weight Θ (Theta), and adds that to current data given a weight 1−Θ). In another embodiment, if a historical data point does not exist with a weight high enough to meet a certain minimum standard, several similar historical data points may be averaged to provide a more reliable data point. For example, if no recent (30 minute) historical travel time for a certain segment, and other favorable choices are not present, other travel times from a similar time of day may be averaged together to provide the predicated travel time for that segment.

Once the weights have been applied, travel times for the one or more historical routes can be calculated. Various route calculation schemes are known in the art, and any suitable scheme may be used. For example, a vector based approach such of a type discussed in “Method of providing travel time”, U.S. Pat. No. 6,317,686 can be used to calculate travel time. U.S. Pat. No. 6,317,686 is hereby incorporated in this specification in its entirety by reference for all purposes. In some implementations, portions of different historical routes may be aggregated to form a different route. For example, consider route R1 and R2. R1 includes portions P1a, P1b, and P1c and R2 includes portions P2a, P2b, and P2c. After applying the various weights, the server system 102 determines that portions P1a, P2b, and P1c are the fastest, and can construct a new route R3 using portions P1a, P2b, and P1c.

In step 225, the server system 102 selects the quickest route, and in step 250, the precision of the prediction is classified. In some implementations, the precision may be classified based on the recency if the historical travel times. For example, a travel time determined from data collect within the previous 24 hours may have a higher precision score than a travel time determined from data collected from within the previous week.

In step 255, based on the determination of step 225, the determined time and classification from steps 230 and 235, respectively, or the determined time and classification from steps 245 and 250, respectively, are transmitted to a client. For example, the server system 102 can transmit a travel time prediction and a precision of the travel time prediction to the client units 101.

In some implementations, a method for suggesting a best route may be implemented using similar steps as described above. For example, after determining a quickest travel time in steps 230 or 245, instead of transmitting the travel time and the travel time classification, the selected route can be transmitted to the client in step 255. In other words, since the quickest route can be a qualitative rather than a quantitative determination, classifying the accuracy of the determination (e.g., steps 235 and 250, respectively) can be omitted while still providing a user with useful and accurate information. A travel time prediction algorithm can be used to find an optimal time, or an optimal route, to reach a friend, or to reach a user or a group of users.

FIG. 3 is a flowchart of a method 300 of sharing locations of people and places using estimated travel times according to one embodiment disclosed here. This method may be employed for one user to share the estimated arrival time of that user to a certain location or for meeting with a selected group of peers. The method may be employed to share one or more estimated travel times without sharing the geographical location or a user, which many users may want to keep private under various circumstances. In this embodiment, such sharing is accomplished through temporary privacy assertions (TAP). In step 302, the web service 114 receives credentials and a temporary privacy assertion (TAP) from a user (e.g., user 301). An example TAP is illustrated in the following table:

TABLE 1

| GUID | timetag | show_travel_{_{—}}time | show_location | expiration_datetime |
|---|---|---|---|---|
| 3897f9be-a214-45eb-9ccb-ed31d61c6826 | alice | true | false | 2007-04-25T03:38:33 |

In the illustrated Table 1, the show_travel_time and show_location fields specify the security permissions granted to the globally unique identifier (GUID) in the table. In addition, the timetag field specifies a user associated with the GUID, and the expiration_datetime specifies when the GUID expires for that user.

In step 303, the web service 114 communicates with an identity provider 304 to use the received credentials to generate an ID for the user. In step 305, the identity provider 304 transmits the ID to the web service 114. The web service 114 then validates the ID to generate a TAP.

In step 306, the TAP generated by the web service 114 is transmitted to a TAP database 132. In step 308, the GUID corresponding to the received TAP is transmitted to web service 114.

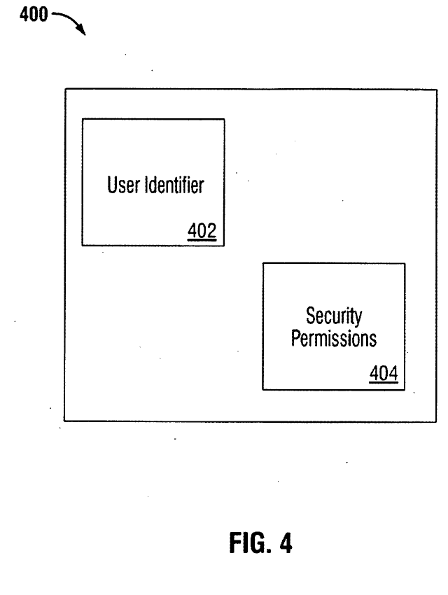

In step 309, the GUID is relayed from the web service 114 to the user 301. In step 310, the GUID is appended to a time tag data structure and sent from the user 301 to the user 311. Time tag data structures are described in more detail in reference to FIG. 4.

In step 312, the time tag data structure received in step 310 is sent by user 311 to the web service 114. In addition, during step 312, the user 311 can transmit credentials to the web service 114.

In step 313, the transmitted credentials of user 311 are transmitted by the web server 114 to the identity provider 304. The identity provider can then generate an ID from the received credentials.

In step 314, the ID of user 311 is transmitted to the web service 114. The web service 114 then verifies the ID of user 311. In step 315, the GUID received by the web service 114 corresponding to the GUID sent by user 301 to user 311 is transmitted to the TAP database 132.

In step 317, the timetag field in the TAP database 132 is transmitted from the web service 114 to a geo-location server 318. The geo-location server can determine the location of the user 301 or specify the parameters of a pre-existing location, to name two examples. For example, the geo-location server 318 can use GPS information provided by the user 301 to the server system 102 to determine a location. As another example, the geo-location server can specify the selected location by latitude and longitude coordinates. In step 319, the determined location is transmitted to web service 114.

In step 320 the destination: (e.g., the location of user 311, the location of user's 311 home, or some other location specified by user 311) is transmitted to the geo-location server 318. As described previously, the geo-location server 318 can determine a location using latitude and longitude coordinates, for example. In step 321, the location of user 311 is transmitted to the web service 114.

In step 322, the location of users 301 and 311 is transmitted from the web service 114 to a time prediction server 323. In some embodiments, the web service 114 and time prediction server 323 may reside on the same server or server system, such as system 102, for example. The time prediction server 323 can determine a travel time using, for example, the method described in reference to FIG. 2.

In step 324, the time prediction server 323 transmits the travel time prediction to the web service 114. In step 325, the web service 114 transmits the travel time prediction to user 311.

In the previously described embodiment, both users 301 and 311 are registered users of the web service 114. Alternatively, if, for example, user 311 is not a registered user of the web service 114, during step 312, in addition to providing the time tag data structure, user 311 can also provide a location, which could be used in step 322. Because user 311 is not registered with the web service 114, the identity verification steps 313 and 314 can be omitted. In other words, since there are no pre-existing user credentials to check (because, for example, the user 311 is not registered) steps 313 and 314 can be omitted. In addition, because the location for user 311 is already provided by user 311, the steps 320 and 321 of determining the location of user 311 can also be omitted.

In depicted method 300, the entities 304, 318, and 323 are illustrated as separate entities. However, it should be noted that they may all be the same entity (e.g., a single server system 102) or multiple implementations of the same entity (e.g., multiple server systems 102) that can be communicatively coupled (e.g., through one or more web services 114). Other methods may, of course, be employed to authorize such access. For example, temporary tokens or limited access passwords may be used.

FIG. 4 shows a data structure 400 for a time tag according to one embodiment. The data structure 400 includes an identifier (ID) 402 and can optionally include security permissions 404. The data structure 400 may be represented by a World Wide Web Universal Resource Locator (URL), for example. Because the data structure 400 may be represented by URLS, time tags defined by data structure 400 can be shared by e-mail or Short Message Service (SMS) and used in any device equipped with a Web browser.

A time tag also may be a static location or a dynamic location. A static location may include locations such as a restaurant, home, or office, for example. A dynamic location may include, for example, moving objects, including vehicles, people, or groups. A time tag can be a system for assigning an owner to a location. A time tag may have more than one name, for example to be used in different contexts, or with different audiences or for different purposes.

A user's presence at a location of a time tag can be obtained or detected by, for example, the name of the time tag that was input by a user, a hint from a signal, peer-to-peer information, such as wireless or some proprietary service, a GPS signal, a cellular ID, or a signal, or code agreed to by the user and the network.

Where a time tag is assigned to a location a time tag may be used to name a location. A time tag can also serve to attach privacy information such as security permissions. A time tag can also be used to share preferences. Thus, a time tag can be a way of caching information. A time tag can cache partial or full results of previous predictions regarding a location. In that way, a time tag can be used, for example, as a way to attach usage history to a location. A time tag can be used as a tool in making an audit trail of a location, or to a location.

In the depicted data structure 400, the ID 402 may be a unique ID referencing a particular user. In other embodiments, an owner may be assigned to a particular location, as expressed by a time tag. The owner may thus be an integral property of a time tag. Preferably, the ID 402 is represented in a human readable format. For example, the ID 402 corresponding to the user John Doe may be “John,” “Doe,” or a combination such as “John_Doe” or “Doe John,” or other combinations thereof.

A time tag can thus be used to enhance the representation of a user in a social network. A user may, if permitted by the network, use a time tag to display the location of the user to a peer. A user may, if permitted by the network, display a travel time prediction to reach a peer, location, or other destination. A user may, if permitted by the network, display optimal travel time, for example, to or from a friend or user.

The security permissions illustrated as 404 in FIG. 4 may specify which information may be viewable by a particular designated user. Temporary assertions privacy database 132 can provide security information corresponding to view permissions for a user's home location, current geo-location, or any other location defined by a user. A time tag can associate any of these view permissions to a particular user. A user may be allowed to explicitly define for that user a privacy level. A user may thus be able to define for that user security permissions. In some implementations, security permissions 404 may be used to determine friendship closeness. For example, a user that has been granted permissions to view information corresponding to another user's geo-location and home location may be considered a closer friend than another user who has only been granted geo-location information.

A social network may have groups or sub-groups. A particular user may, for example, wish to join some groups essentially permanently and some other groups temporarily. A life time resident of one city may have no interest in being alerted to information about changing exhibits, or proximity to, museums in that one city, but may when traveling have an interest in such information in cities visited. A network manager can construct groups, sell groups, rent groups, and so on using this social network information. A particular user can access the information relating to certain groups as such access is permitted by the network. For example, registrants to a certain event may be automatically made members of a group relating to that event. The network can make use of stored user information. The security permissions of a user can impact how that information is used or disseminated.

By defining security permission, a user can hide (become invisible to others) or alter his location as seen by other users. A user can set his location, if permitted by the network, to appear to be at an existing time tag. A user can appear to be stationary at a location of a static time tag, or for example, at specified coordinates. A user can appear to be traversing a route as based on a dynamic time tag. A user can have one or more identifiers. A user may have reason to disclose some information to some, users, but not to others. A user may have reason to protect route information or historical route information. A user may have reason to disguise information about the user or the user's location. A user may have reason to disclose information about a location, or about a particular user, to one user but not to another. A user may have reason to prevent the location of the user from becoming a proxy for the user. A user can also at anytime terminate a social networking relationship with any particular user.

A user can set security permissions of the user using a security permission of a group. A user can set a security permission such that only the name of a location, but not for example, the coordinates of the location, are disclosed. The time tag may have a setting that provides that if the user or owner is at a certain location or locations, then only the name of the location will be displayed. The time tag may have a setting that provides that if the user or owner is at a certain location or locations, then only travel time but not coordinates will be displayed. In this embodiment, or any embodiment with this feature, the security permissions of a time tag may change to specifically match a location.

In a preferred embodiment, when a user enters a sensitive area the location of the user can be hidden. Conversely, when a user whose location coordinates were previously undisclosed enters a location that has not been designated by the security permissions for non-disclosure, the location of the user can become available. A user, if permitted by the network, can attach security permissions to information. This information regarding security permissions may be stored in the TAP database. In this way, a user may restrict information that is displayed based upon the proximity of another user, any specific time tag, audience or recipient restriction information (including permission lists), or security permissions, for example.

In one embodiment, the security permissions are defined as a GUID. The GUID can have an expiration date or it can be revoked (or otherwise modified) by a user of the system. For example, John Doe can revoke the GUID granting Jane Smith access to his information. By revoking a GUID, the amount of information disseminated to a particular user is reduced. For example, by revoking the GUID, John Doe can deny Jane Smith information related to John Doe's current location, an estimated time to John Doe's current location, or other personal information related to John Doe, such as the geo-location of his home, or place of employment, to name two examples. Similarly, by making modifications to the information that Jane Smith can access, John Doe can effectively modify her GUID.

By way of example, the data structure 400 can be generically defined as <protocol>://<rooturl>/<owner>[/<name>][/2/destination_timetag][/<latitu de>,<longitude>][/url><guid>]. For example, using the data structure 400 a URL http://time2me.com/doe/home can be generated specifying John Doe's home location. The resource referenced by the URL can include information specifying the geo-location of John Doe's home, and estimated travel time to John Doe's home, to name two examples. To access this information, John Doe can set the resource referenced by the URL to be publicly viewable, or John Doe can enable certain users with various view permissions. For example, a GUID can be added to the URL to provide view permissions. A URL with an added GUID may be http://time2me.com/doe/home/00000000-0000-0000-0000-000000000000, for example. The previously illustrated URL when generated by a time tags web service (e.g., web service 114) can grant certain permission rights to access information about a user's home or other locations, such as current employer, for example. The permission rights are defined based on the user that communicates with the web service. For example, as described previously, and as shown in FIG. 4, John Doe can configure users and their respective permission rights so that when Jane Smith communicates with the web services 114, she automatically receives security permissions 404 (see FIG. 4.), in the form of a GUID, embedded in the URL from the server system 112. Typically, the GUID is stored on a server (e.g., the server system 102) for later use. By way of example, the GUID may be defined by the following regular expression:

[0-9a-fA-F]{8}-[0-9a-fA-F]{4}-[0-9a-fA-F]{4}-[0-9a-fA-F]{4}-[0-9a-fA-F]{12}

In addition, the data structure 400 may be used to generate time prediction information between one or more locations. For example, the URL http://time2me.com/doe/home/2/smith/home can generate travel time predictions from John Doe's home to Jane Smith's home. As another example, the URL http://time2me.com/doe/home/2/38.9764924855394,−9.1186523437500036 can generate travel time predictions from John Doe's home to the specified latitude and longitude (e.g., 38.9764924855394 and −9.1186523437500036, respectively). In addition, the example URL http://time2me.com/doe/2/smith can generate travel time predictions from John Doe's current geo-location to Jane Smith's current geo-location. Any or all of the previously described example URLs can be combined with a GUID for added security. For example, http://time2me.com/doe/2/smith/00000000-0000-0000-0000-000000000000 can be used to specify view permission for information corresponding to Jane's Smith geo-location.

By way of example, the time tag data structure can be defined by the following schema:

```
    <s:schema  elementFormDefault=“qualified”
targetNamespace=“http://timebi.com”>
    <s:complexType name=“TimeTag”>
        <s:sequence>
        <s:element  minOccurs=“1”  maxOccurs=“1”  name=“ID”
type=“s:long” />
        <s:element  minOccurs=“0”  maxOccurs=“1”
name=“Namespace” type=“s:string” />
        <s:element minOccurs=“0” maxOccurs=“1” name=“Name”
type=“s:string” />
        <s:element  minOccurs=“0”  maxOccurs=“1”
name=“FriendlyName” type=“s:string” />
        <s:element  minOccurs=“0”  maxOccurs=“1”
name=“Description” type=“s:string” />
        <s:element minOccurs=“0” maxOccurs=“1” name=“Avatar”
type=“s:string” />
        <s:element minOccurs=“1” maxOccurs=“1” name=“Privacy”
type=“tns:PrivacyStatus” />
        <s:element minOccurs=“0” maxOccurs=“1” name=“Domain”
type=“s:string” />
        <s:element minOccurs=“0” maxOccurs=“1” name=“Position”
type=“tns:Position” />
        <s:element  minOccurs=“1” maxOccurs=“1” name=“Icon”
type=“tns:Icon” />
        <s:element  minOccurs=“0” maxOccurs=“1” name=“Vias”
type=“tns:ArrayOfVia” />
        </s:sequence>
      </s:complexType>
      <s:simpleType name=“PrivacyStatus”>
        <s:restriction base=“s:string”>
        <s:enumeration value=“Invisible” />
        <s:enumeration value=“ShowTime” />
        <s:enumeration value=“ShowTimeAndPosition” />
        <s:enumeration value=“ShowPosition” />
        </s:restriction>
      </s:simpleType>
      <s:complexType name=“Position”>
        <s:sequence>
        <s:element minOccurs=“1” maxOccurs=“1” name=“Latitude”
type=“s:double” />
        <s:element minOccurs=“1” maxOccurs=“1” name=“Longitude”
type=“s:double” />
        <s:element minOccurs=“1” maxOccurs=“1” name=“Altitude”
type=“s:double” />
        <s:element minOccurs=“1” maxOccurs=“1” name=“Bearing”
type=“s:int” />
        <s:element minOccurs=“1” maxOccurs=“1” name=“Speed”
type=“s:double” />
        <s:element  minOccurs=“0”  maxOccurs=“1”
name=“Description” type=“s:string” />
        <s:element minOccurs=“1” maxOccurs=“1” name=“Time”
type=“s:dateTime” />
        <s:element  minOccurs=“1”  maxOccurs=“1”
name=“OperatorID” type=“s:int” />
        <s:element minOccurs=“1” maxOccurs=“1” name=“LAC”
type=“s:int” />
        <s:element minOccurs=“1” maxOccurs=“1” name=“CELLID”
type=“s:int” />
        <s:element  minOccurs=“1”  maxOccurs=“1”
name=“SignalStrength” type=“s:int” />
        <s:element minOccurs=“0” maxOccurs=“1” name=“OtherInfo”
type=“s:string” />
        </s:sequence>
      </s:complexType>
      <s:simpleType name=“Icon”>
        <s:restriction base=“s:string”>
        <s:enumeration value=“Person” />
        <s:enumeration value=“Place” />
        </s:restriction>
      </s:simpleType>
      <s:complexType name=“ArrayOfVia”>
        <s:sequence>
        <s:element  minOccurs=“0”  maxOccurs=“unbounded”
name=“Via” nillable=“true” type=“tns:Via” />
        </s:sequence>
      </s:complexType>
      <s:complexType name=“Via”>
        <s:sequence>
        <s:element  minOccurs=“0” maxOccurs=“1” name=“Times”
type=“tns:ArrayOfTime” />
        <s:element  minOccurs=“0” maxOccurs=“1” name=“Name”
type=“s:string” />
        </s:sequence>
      </s:complexType>
      <s:complexType name=“ArrayOfTime”>
        <s:sequence>
        <s:element  minOccurs=“0”  maxOccurs=“unbounded”
name=“Time” nillable=“true” type=“tns:Time” />
        </s:sequence>
      </s:complexType>
      <s:complexType name=“Time”>
        <s:sequence>
        <s:element minOccurs=“1” maxOccurs=“1” name=“Minutes”
type=“s:double” />
        <s:element minOccurs=“1” maxOccurs=“1” name=“Precision”
type=“s:int” />
        </s:sequence>
        <s:attribute  name=“Mode”  type=“tns:MobilityMode”
use=“required” />
      </s:complexType>
      <s:simpleType name=“MobilityMode”>
        <s:restriction base=“s:string”>
        <s:enumeration value=“driving” />
        <s:enumeration value=“walking” />
        <s:enumeration value=“cycling” />
        </s:restriction>
      </s:simpleType>
    </s:schema>
```

The time tag schema can be used to represent time tags in various ways. For example, here is a time tag encoded in an XML format:

```
  <TimeTag>
    <ID>1</ID>
    <Namespace>alice</Namespace>
    <Name>alice</Name>
    <FriendlyName>Alice</FriendlyName>
    <Description>Alice personal time tag</Description>
    <Avatar>default</Avatar>
    <Privacy>ShowTimeAndPosition</Privacy>
    <Position>
    <Latitude>38.696408333333331</Latitude>
    <Longitude>−9.2116349999999976</Longitude>
    <Altitude>0</Altitude>
    <Bearing>0</Bearing>
    <Speed>0</Speed>
    <Time>2007-04-24T18:20:15</Time>
    <OperatorID>0</OperatorID>
    <LAC>0</LAC>
    <CELLID>0</CELLID>
    <SignalStrength>0</SignalStrength>
    </Position>
    <Icon>Person</Icon>
    <Vias>
    <Via>
      <Times>
      <Time Mode=“driving”>
      <Minutes>15</Minutes>
      <Precision>0</Precision>
      </Time>
      </Times>
      <Name>default</Name>
      </Via>
      </Vias>
      <LastPositionUpdated>2007-04-
24T18:20:15</LastPositionUpdated>
  </ TimeTag >
```

The usage history of a time tag, which may be stored in a database 104, may be used by an owner of a time tag to control and understand the security implications of a time tag. An owner can determine whether actual evidenced usage corresponds to the owner's intent. If the owner is not comfortable, then an owner has the potential to revise any security or privacy setting. An owner may also be able to spot a malfunctioning of the system. An owner may conversely feel that the travel time prediction network system runs as expected.

Time tags also can be used to attach to allocation access controls. A location, expressed by a time tag, may be associated with a list or database. There may be access control rules (permitted lists or non-permission lists). A permitted list is a list the members of which a user is willing to disclose more information as compared to the members of a non-permission list. The user may chose to control the amount or type of information disclosed or may choice to rely on the system defaults of the travel time prediction network.

In some implementations, the time tag may also include settings that specify how a user's position is displayed to other users. For example, the time tag may include one or more fields that specify a symbolic rather than a coordinate based disclosure of a particular user's location. As another example, the time tag may include one or more fields that specify a travel time rather than a coordinate based disclosure of a particular user's location.

FIG. 5 is a flow chart of a method 500 of triggering notifications based on time proximity. In step 502, the web service 114 receives a position from the client device, such as client unit 101. For example, a GPS enabled phone can send position information determined by the GPS system.

In step 504, the web service 114 transmits the position to a timer fence server 506. In step 508, the time fencing server 506 accesses the time fence database 130 and retrieves time fence information. For example, the time fence information can be represented by the following table:

TABLE 2

| latitude | longitude | minutes_to_{_{—}}center | message |
|---|---|---|---|
| 38.9764924855394 | −9.118652343750 | 15 | You are near Cafe Roma |

In the illustrated table 2, the latitude and longitude values specify the center of the fence, and the minutes_to_center specifies the number of minutes in all directions from the center. This information can be used to construct a time fence. As described previously, the fence is constructed based on the time to the center. A time fence includes a dynamic travel-time bounded perimeter around a location. Because the time to center can be impacted by several factors (e.g., traffic, building construction, or other events), the fence will typically not be uniform in all directions. Nonetheless, because travel time is often more relevant than physical distance, a time fence is often more relevant for, for example, advertising or broadcasting, or sending messages to a group, or to nearby friends or peers. Using a time fence, a user can send a message that another approaches, or that others are near, or the time to a destination (such as a pub).

In step 510, the timer fencing server 506 transmits the position of the user and the one or more time fence centers to the travel time prediction server 323. In some implementations, every time fence center in the time fence database 130 is transmitted to the travel time prediction server 323. The travel time prediction server may determine a predicted time for the user to reach the one or more received time fence centers. In some implementations, a filter is applied to the time fences to exclude a time fence center that falls outside a predetermined distance. In some applications, the network may employ a delay, filter, neural network, hysteresis, or other method to avoid strain on the network from excessive alerts where any particular user is close to the boundary of a time fence. Alerts otherwise are typically sent when a user enters or leaves a time fence.

In step 512, time predictions for the remaining unfiltered time fences is transmitted to the time fencing server 506. For each received travel time prediction, if the received travel time prediction is less than or equal to the time to the center (e.g., minutes to center illustrated in table 2) of a time fence entry in the time fence database 130, the time fencing server 506 can generate a notification. For example, the string “You are near Café Roma” in the message field of a time fence database 130 table entry can be used to generate a notification message.

In step 514, the notification message is sent to the web service 114. In step 516, the notification message is transmitted from the web service to the client device 101. The time fence scheme taught herein may be employed in various scenarios where geographic proximity to a certain location has previously been employed. Receiving notifications based on the proximity of places has been used in many scenarios like geographic-based advertising (e.g. “System and method for providing geographic-based advertising”, U.S. Pat. No. 6,452,498) or children locators (e.g. System for localizing and sensing objects and providing travel time predictions, U.S. Pat. No. 6,847,892). These two U.S. patents are hereby incorporated in this specification by reference for all purposes. Time fences may also be used in any other scenario where such travel time knowledge is desired. For example, time fences may be used in friend finder applications. For example, the message field of the time fence table can include the string “You are near % s”, where “% s” is a variable the value of which can be specified based on the ID of an identified peer. Moreover, the time fences can be used to track packages, for example, notifications can be sent to a user once a package is within a specified time from their home, their office, or other specified location. The user or peer can track the package based upon this notification.

FIG. 6 is a screenshot 600 of selecting peers in a travel time prediction application according to one embodiment. As depicted by screenshot 600, the travel time prediction application includes a user interface in peer display mode. The user interface includes regions 602, 604, 610, 612, 614, and 616. Region 602 shows the users' current state. For example, they can be moving or stationary. This can reduce the amount of network traffic. For example, when the state is set to stationary, the user application may avoid sending position updates. Instead, the bandwidth can be dedicated to receiving updates from the server system 112.

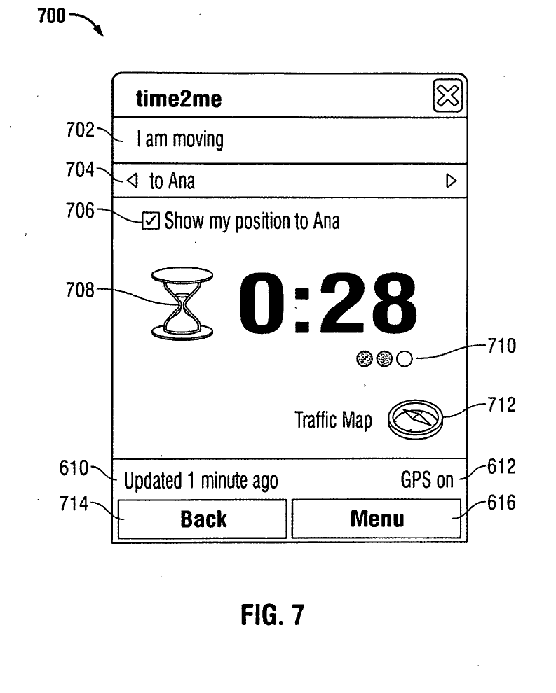

The user interface region 604 displays one or more peers and their respective estimated travel times. For example, consider peer 606, the peer's name is displayed (e.g., Ana) along with time information 608. The time information 608 specifies an estimated time of arrival (e.g., fifteen minutes) and a precision value for the time information. (e.g., two out of three, where one is the least accurate and three is the most accurate). In some scenarios, the peer information may not be available (e.g., because the peer has not granted security permission to the user). For example, peer 609 does not include time information or a precision value because the user does not have permission to view that particular information regarding peer 609. In some implementations, the user interface region 604 can include a scrolling region. For example, if there are more peers in the user interface region 604, a scroll region can allow a user to scroll through the entire list of peers. Moreover, the user interface region 604 allows a user of the travel time prediction application to select a peer displayed on the screen. For example, a user can use an input device (e.g., a mouse, a stylus, or other pointing device) to select a peer (e.g., by tapping a stylus or clicking a mouse button near the representation of the peer). Selecting a peer displays additional information corresponding to the selected peer, as described in more detail in reference to FIG. 7.

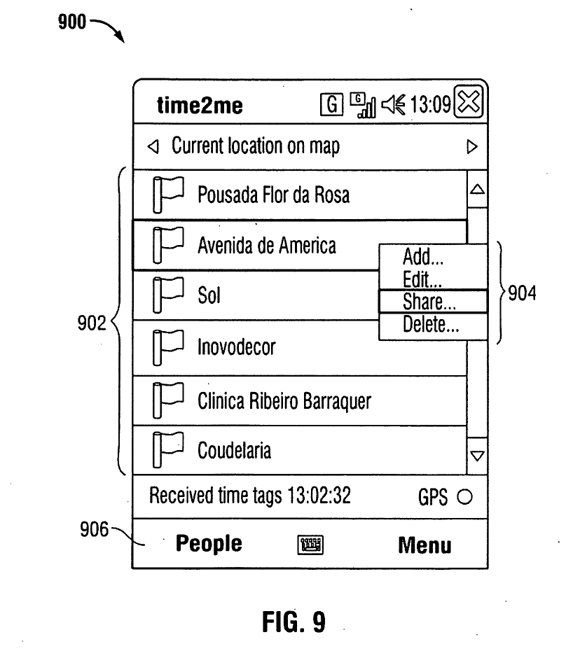

The user interface region 610 displays additional status information, such as a value corresponding to the last time updated travel time information was received. For example, as shown by the screen shot 600, the last travel time information update occurred three minutes ago. User interface region 612 displays the status of the GPS (e.g., on or off). User interface region 614 allows the user of the travel time prediction application to display a list of places. Once selected, a list of possible locations can be displayed, such as the list of places displayed in FIG. 9, for example. In some implementations, the list of places can be determined by the security parameters in the data structure 400. For example, John Doe can view the list of his restricted locations (e.g., his home, his place of work, and the like), along with public places (e.g., parks, restaurants, monuments, and the like) but depending on the security permission set by his peers, he may or may not be able to view their restricted locations.

The user interface region 616 allows the user of the travel time prediction application to display a menu. The menu can include, for example, user interface components directed to turning the travel time prediction application on or off, configuring notifications (e.g., arrival notifications or time fence notifications), modifying the graphical representations, modifying update frequency, among other things.

FIG. 7 is a screenshot 700 of displaying a travel time prediction in a travel time prediction application according to one embodiment. As depicted in the screenshot 700, the screen shot includes user interface in a time-to-peer display mode. The user interface includes regions 702, 704, 706, 708, 710, and 712. In addition, the user interface includes regions 610, 612, and 616 which are described in reference to FIG. 6.

The user interface region 702 displays the users' state, as defined by user interface region 602, as described in reference to FIG. 6. The user interface region 704 allows the user of the travel time prediction system to select other users without return to the user selection screen (e.g., FIG. 6). For example, referring to FIG. 6, clicking on the left (i.e., back) arrow selects the previous user in the list, which in this case would be Carlos. By clicking on the right (i.e., forward) arrow, the user can select the next peer in the list, which in this case would be Miguel. The arrows can be pressed multiple times allowing the user of the travel time prediction system to loop through the users in the list in both forward and backward directions.

The user interface region 706 allows the user to specify whether or not their position on a map (e.g., maps provided by MapPoint, MapQuest, Google Maps, Yahoo! Maps, or the like) will be viewable by a selected user, in other words, will be visible to a selected user. For example, as illustrated by the screenshot 700, the check-box 706 currently specifies that a user is allowing the position of that user on the map to be shown to Ana.

The user interface region 708 provides a travel predication to the current destination. In the illustrated example, the user interface region 708 provides a travel time prediction of twenty-eight minutes to Ana's current geo-location. In addition, the user interface region 710 provides an accuracy metric for the travel time prediction. As described previously in reference to FIG. 2, the accuracy metric can be generated by determining the relevancy (e.g., recency) of the data used in the travel time prediction. For example, the more current the data used, the higher the relevancy and the higher the accuracy metric. As illustrated in screen shot 700, the current travel time prediction has an associated accuracy of two out of three, where one is the lowest and three is the highest accuracy, for example. Other selected granularities for the accuracy metric can be used. For example, a scale of one to five, a scale of one to ten, or other scales can be used.

The user interface region 712 allows the user of the travel time prediction application to display a map. The displayed map can show stored locations, peers, the user's current geo-location, and other information related to travel time predictions. The maps is described in more detail in reference to FIG. 8. The user interface region 714 allows the user of the travel time prediction application to return to the previous screen (e.g., the screen illustrated in FIG. 6).

FIG. 8 is a screenshot 800 of displaying a map, locations, and a travel time to a selected destination in a travel time prediction application according to one embodiment. As depicted in the screenshot 800, the screen shot includes a user interface in a map mode. The user interface includes regions 802, 804, 806, 808, 810, and 812.

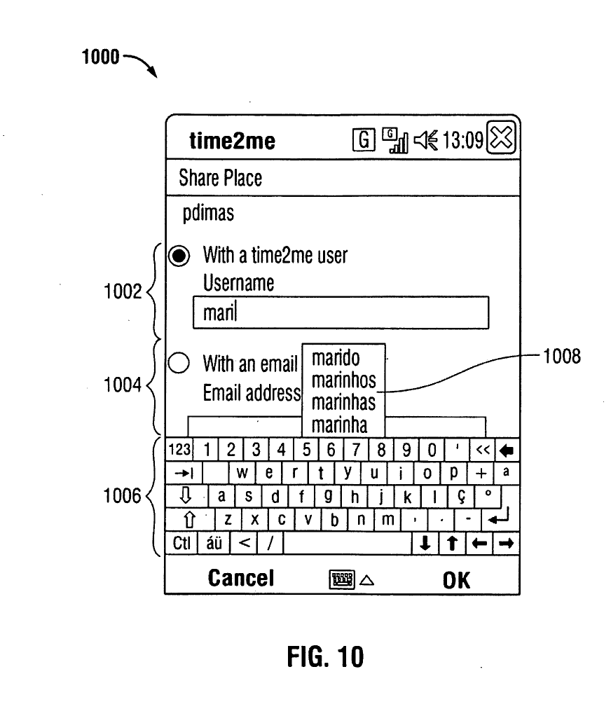

The user interface region 802 displays the current location of the user, and preferably provides an arrow indication of travel direction. The user interface region 804 displays a location of a nearby peer. As described previously, the location of a nearby peer is allowed because the user has been given permission by the peer to view the peer's location. The user interface region 806 displays one of many locations that the user has registered or that has been shared by another peer. Registering and sharing a location is described in more detail in reference to FIGS. 9 and 10. The user's geographic trace is displayed as points 814 and 816. Trace points with large distances between them are preferably shown as black, and closely spaced trace points shown as red, giving a visual indication of speed along the geographic trace depiction.

The user interface region 808 displays the predicted travel time and the associated accuracy metric. For example, the predicted travel time is twenty-six minutes and the accuracy metric is three out of three (i.e., the highest possible accuracy in this particular case using a one to three scale).

The user interface regions 810 and 812 allow the user to zoom in or zoom out, respectively. For example, as illustrated by the screen shot, the user is using a stylus to zoom out on the map. This can allow the user to view more of the map, which in turn may allow the user to see additional locations, peers, or both.

FIG. 9 is a screenshot 900 of locations and location management methods in a travel time prediction application according to one embodiment. As depicted in the screenshot 900, the screen shot includes a user interface in a mode to manage locations, or in a locations management mode. The user interface includes regions 902, 904, and 906.

The user interface region 902 displays a list of the locations known to the user. The list displayed in user interface region 902 can include locations that are added by the user, shared by peers, or combinations thereof.

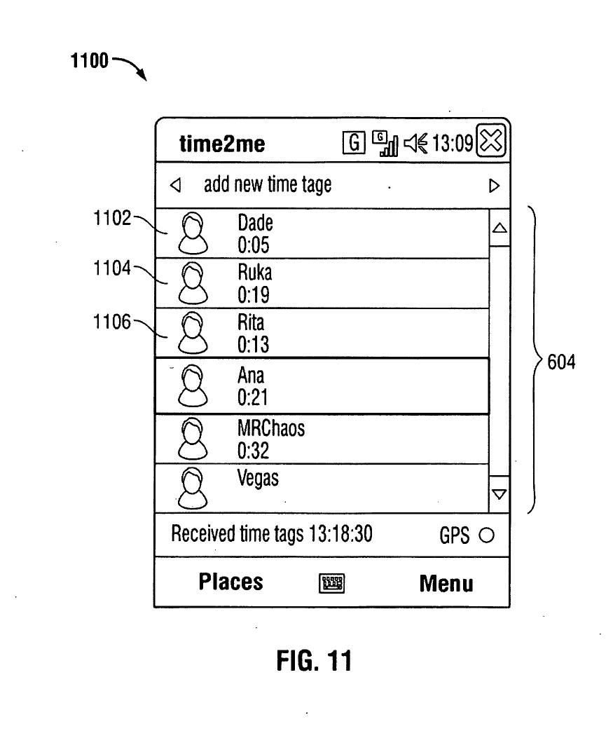

The user interface region 904 displays a few example methods that can be used for maintaining a list of the locations. For example, a user can select “Add” to add a location manually. In addition, a user can select “Edit” to edit the properties of the location, such as the security permissions, the geo-location, or other properties. A user can also select “Share” to share a location with peers. Sharing a location is described in more detail in reference to FIG. 10. Moreover, a user can remove a location from the list by selecting “Delete.” The user interface region 906 allows the user to return to list of peers, such as the list displayed in FIG. 6 or 11.

FIG. 10 is a screenshot 1000 of sharing a location with a peer in a travel time prediction application according to one embodiment. As depicted in the screenshot 1000, the screen shot includes a user interface in a share place editing mode. The user interface includes regions 1002, 1004, 1006, and 1008.

The user interface region 1002 allows the user to add a peer by providing the user name of the peer. Typically, the user name corresponds to a user already registered with the web service 114. The user interface region 1004 allows the user to add a peer by providing the email address of a peer.

The user interface region 1006 allows the user to select the characters that correspond with the peer's username or the peer's email address. The user interface region 1008 can automatically suggest a user name or email address based on previously entered information. For example, the suggested name “marinhos” is suggested after the user enters a few characters, such as “mari.” In the depicted screen shot 1000, the suggested name is fading out because the entered text “maria” no longer matches a region of the string “marinhos.”

FIG. 11 is a screenshot 1100 of peer movement information in a travel time prediction system according to one embodiment. The screenshot 1100 shows a peer status display mode similar to the screen shoot 600. For example, a list of peers is displayed in user interface region 604. However, the user interface includes additional icons 1102, 1104, and 1106.

User interface icons 1102, 1104, and 1106 may be employed to display the movement information of the corresponding peers. This information can be used, for example, to determine if a peer is moving to meet you. User interface icon 1102 (e.g., the “play” icon) can be used to represent a peer who is moving or has moved within the last five minutes. User interface icon 1104 (e.g., the “pause” icon) can be used to represent a peer who has moved within the last fifteen minutes. The user interface icon 1106 (e.g., the “stop” icon) can be used to represent a peer who has moved within the last thirty minutes.

FIG. 12 is a screenshot 1200 of selecting a best route in a travel time prediction system according to one embodiment. As depicted in the screenshot 1000, the screen shot includes a user interface in a route selection mode. The user interface includes icon 1202, user interface region 1204, and icon 1206, among previously described regions 612 and 808.

By way of example, the user interface icon 1202 represents the user's starting location. In addition, the user interface icon 1204 represents the user's selected destination (e.g., as selected from the list displayed in FIG. 9). The user interface region 1206 represents one or more travel routes. The travel routes represented by the user interface region 1206 can be broken into portions and can be colored coded to provide additional information. For example, portions 1206a and 1206d may be colored yellow because they are the only known route for the respective portions. Portion 1206b and portion 1206c start and end in the same place, but portion 1206b may be colored red while portion 1206c may be colored green to illustrate that portion 1206b is predicted to be slower than portion 1206c. Color coding information can be used by a user to aid in selecting a route.

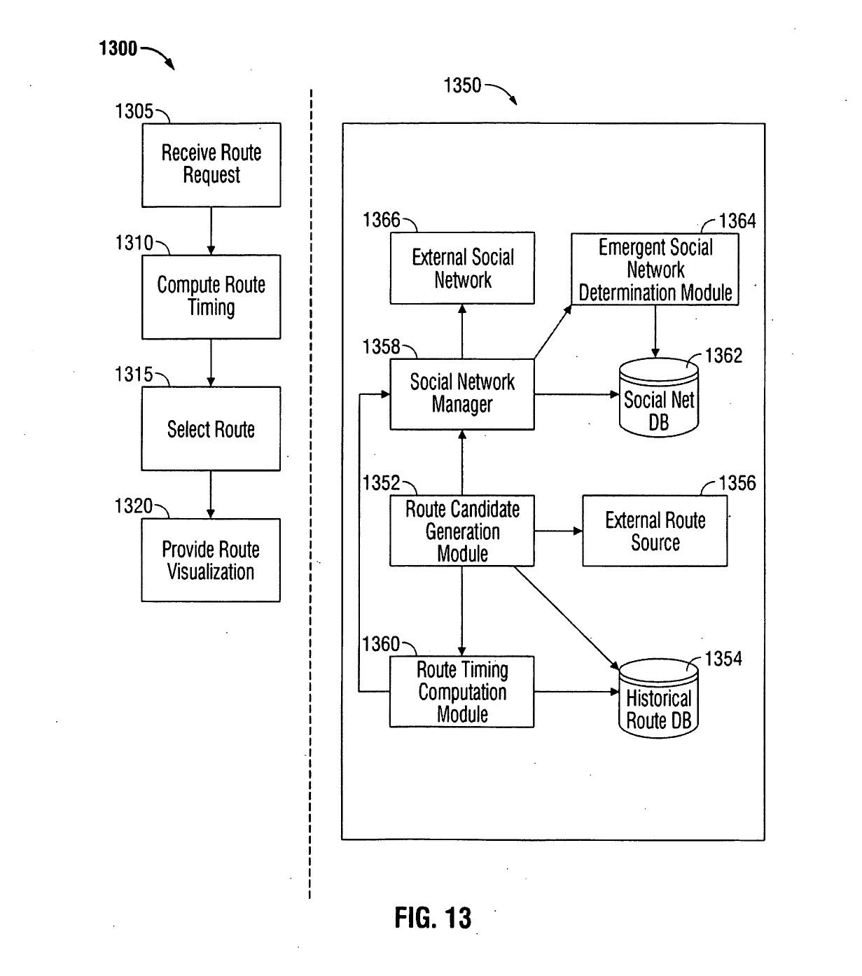

FIG. 13 is a flow chart of a travel time prediction social networking scheme 1300 according to one embodiment of a system 1350. For convenience, FIG. 13 is described in reference to a system 1350, however other modules or structures may be utilized when processing the scheme 1300. For example, the scheme 1300 may be processed by server system 102 described in reference to FIG. 1. FIG. 13 shows one embodiment of a set of paths of information. Typically, in step 1305, a user requests a route. For example, a user request may be received by a route generation module 1352. In the illustrated example, the route generation module 1352 has at least four possible choices or inputs for comparison in this example. The module 1352 can draw upon a database of historic route information 1354, upon external route information sources 1356, upon information from a social network, in this illustration filtered through a social network manager 1358, or upon a route timing computation module 1360. The module 1352 can utilize one or more algorithms, heuristics, or combinations thereof to determine a candidate route. In the illustrated example, the information filtered through the social network manager 1358 could include information from any social network database 1362, or an emergent social network determination module 1364, including ongoing social network data, or external social network databases or other sources. Moreover, the social network manager 1358 can be configured to communicate with any number of external social networks 1366, which may provide additional social network data. In addition, in the illustrated example, the emergent social network determination module 1364 draws upon a social network database 1362, and the social network manager 1358 draws upon route timing computation module 1360 for information.

Furthermore, the emergent social networking module 1364 provides capabilities for detecting the proximity of a group of people in a time or place. Typically, this can correlate to a venue where likeminded people gather, and are therefore more likely to form a natural social network. For example, like minded people may attend the same genre of movies. In some implementations, travel time estimates should be adjusted on basis of membership in the detected emergent group. For example, Bond film watchers may be more likely to drive faster and therefore their travel time estimates should be modified accordingly. As another example, the emergent social networking module 1364 can detect the neighborhoods people frequent and assign socioeconomic status or other relevant information on that basis.

In step 1310, the system 1350 may compute route timing. For example, the route computation generation module 1352 illustrated in FIG. 13 shows that route computation module 1352 looks to the route timing computation module 1360 for a computed route time. The route timing computation module 1360 takes into consideration historical route information, from the historical route database and to the social network manager 1358. A travel time computation (e.g., as determined by the route timing computation module 1360) is typically a prediction using a number of factors. For example, the factors typically include at least some of the distance information to a location, traffic volume, road construction, weather conditions, or accidents or disruptions that can impact travel time. Any route can be provided in real time to recommend the fastest route as conditions change. Once routes are computed, taking into account information including the flows of information shown in FIG. 13, then, in step 1315, a route is selected. In step 1320, the selected route is provided as a route visualization. For example, a server engine may process security credentials submitted by the client or user and those security credentials may specify which users are allowed to access this route information, or other information and provide a visualization similar to the example depicted in reference to FIG. 8.

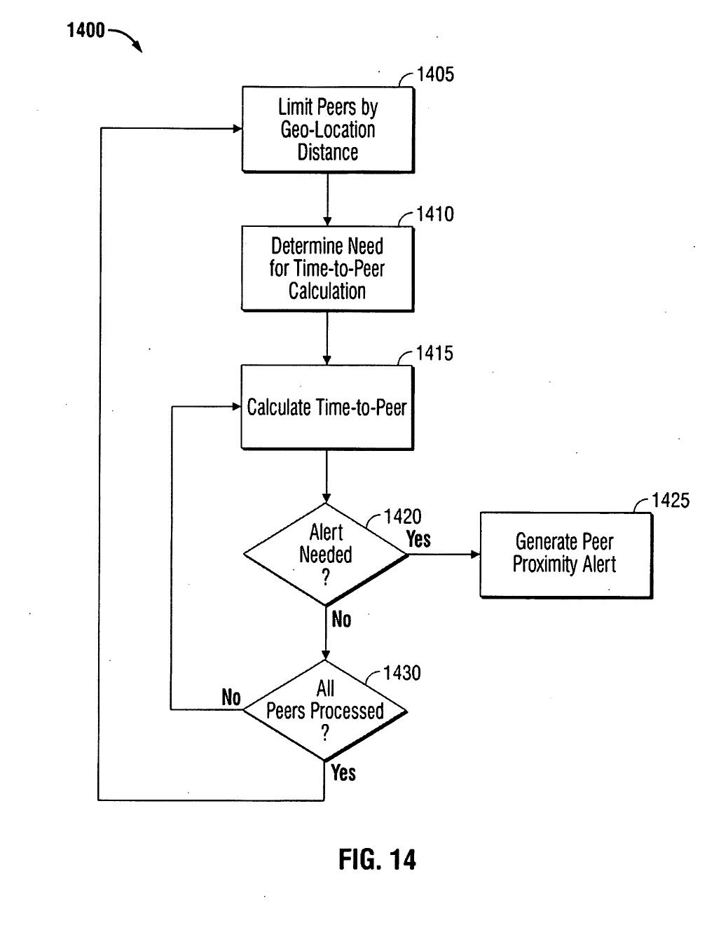

FIG. 14 shows a flow chart of travel time prediction social networking scheme 1400 according to another embodiment of information in an embodiment where a user, depicted as “Client,” is alerted by the social network to the proximity of a peer. In the depicted example, a client can be alerted by the social network to the proximity of a peer. For convenience, scheme 1400 is described in reference to system 1350, however other modules or structures may be utilized when processing the scheme 1400. For example, the scheme 1400 may be processed by server system 102 described in reference to FIG. 1.

In step 1405, the set of potential peers is limited by the location or proximity of all peers. Only peers located within a certain proximity, for one example within or proximate to a time fence, are considered. The universe of peers considered for this first proximity determination is updated from time to time. Any update can be provided in real time. The universe of eligible peers is pooled from time to time and that information is available to the initial proximity determination. The set of eligible peers is drawn from a social network database (e.g., social network database 1362).

In step 1410, the system determines if there is a need for any time-to-peer calculations. For example, the user may be waiting for a peer. The peer may be an authorized user who has set security permissions. The user to be alerted may not be entitled to any information other then a proximity alert. The proximity alert may be set for example for distance or time. The time, for example, may be set for 15, 5, 3, 1 or any other set of alert points. These can be determined by default, by the social network manager, or by the user.

A restaurant or other advertiser may make use of information from the travel time prediction network system as exampled in FIG. 14. A restaurant for example may disseminate its location or other pertinent information to all subscribers entitled to receive such information as a proximity alert. A restaurant may disseminate time, location, menu, ratings, specials, or other information to those within the social network who the system detects as suitably dynamic. A restaurant may disseminate similar information to users that enter, or that for a suitable period of time remain, in a designated time fence.

The social network manager or owner can control the use of certain proximity, predicted arrival time, or other information. A social network manager, or other entity, may auction information to a restaurant based upon proximity to that restaurant, direction of travel, expression of interest, security permissions, or other information. The social manager may use the information provided by the users of the social network to add value for advertising timing or targeting. For example, a particular user may have provided information regarding the types information desired or types of ratings from others, similarly situated in the social network, that that user desires to receive in the way of alerts. This information can be related to any social group that a particular user has designated.

As shown in FIG. 14, once the set of peers is determined by the peer proximity determination, in step 1415, the time to each peer or a subset of peers is calculated. That time-to-peer information may be recalculated or otherwise updated from time to time. The time-to-peer calculation may be performed with any of the information or by any of the methods discussed in reference to subject matter described herein. For example, the time-to-peer information may be calculated or recalculated using a social networking travel time prediction algorithm. In step 1420, the need or desirability of an alert may be determined, as disclosed, by for example, a user, or by the social network manager, or by default. If a peer proximity alert should be issued, then in step 1425, a peer proximity alert is generated.

If an alert is not needed, then in step 1430, the system determines in all of the peers in the set of peers have been processed. If they have not, the system may generate another time-to-peer calculation as described in reference to step 1415. If all peers have been processed, the system may continue another iteration of scheme 1400. Thus, scheme 1400 may be executed indefinitely, or until a the system determines to cease the execution of scheme 1400.

In FIG. 14, the information regarding the decision of alerting a particular user or client is drawn upon by the pool of all eligible peers. The information may be used to initiate the information flow process with regard to limiting peers by their geo-location. The information may be drawn upon for the recalculation of the proximity of a peer that would signal an alert.

Using the methods and systems described herein, members of the social network(s) may mesh in a positive feedback loop. For example, friends may be quickly linked together, which may also trigger the incorporation of additional users through emergent social network methods, importing existing social networks from the users, or collecting other social network information through a variety of techniques. The positive feedback loop has may advantages, including increasing the density of traffic observations that are relevant to members of the social network or reducing the number of users that an initial marketing campaign targets (e.g., because the campaign can be quickly disseminated through the social network of the particular users).

A number of embodiments have been illustrated and described. Nevertheless, it will be understood that various modifications may be made without departing from the spirit or scope of the subject matter. For example, various construction materials may be used in various arrangements in various dimensions having various relationships. Further, other techniques besides the depicted neck and head designs may be employed to do center of gravity shifting. Many different icons can be employed. Many different colors may be employed. Accordingly, other variations are within the scope of the following claims.

1. A method of providing travel time prediction services comprising:
receiving a travel time prediction request from a first user including a first indicator of a current location and a second indicator of a destination;
checking a historical data warehouse for the existence of historical route information including one or more segments of a route from the current location to the destination;
if historical route information is found calculating a travel time predication based on the historical route information;
transmitting the travel time prediction to a user, which may be the first user or another user; and
transmitting the travel time prediction to one or more user-designated peers of the user.

2. The method of claim 1 further comprising classifying the precision of the travel time prediction.

3. The method of claim 1 further comprising updating the historical data warehouse with a current stamp and a current client location.

4. The method of claim 1 further comprising invoking a time prediction API running on a time prediction server.

5. The method of claim 1 further comprising weighing one or more segments employed in calculating travel time prediction based on characteristics of the historical route information.

6. A method of providing notifications to traveling users, the method comprising:
receiving a first indicator of a present location from a traveling user;
requesting a calculation of an estimated travel time for the traveling user to reach the center of one or more designated time fences; and
notifying the traveling user that they are within at least one of the time fences.

7. The method of claim 6 in which the step of requesting the calculation is accomplished by transmitting a request to a time fence server.

8. The method of claim 6 further comprising notifying one or more user-designated peers that the user is within at least one of the time fences.

9. A method of sharing travel time notifications between users of a system, the method comprising:
receiving, from a first traveling user, a time tag including a globally unique identifier (GUID) and a temporary privacy assertion authorization;
verifying, in response to a request from a second user, the authority of the second user under the temporary privacy assertion authorization;
transmitting a first user travel time a prediction to the second user.

10. A method of generating a time fence object comprising the steps:
receiving from a generating user a first indication of a time fence center location and a second indication of a time fence travel time;
calculating, based on historical and current travel data, predicted travel times to the time fence center location along one or more routes;
identifying a time fence position on each of the one or more routes, that position having a predicted travel time equal to the time fence travel time;
saving in memory a time fence data structure containing the time fence center location, the time fence travel time; and the time fence position for each of the one or more routes.

11. The method of claim 9 further comprising transmitting an indication to the generating user of the time fence positions, the indication adapted for display on a map.

12. The method of claim 9 further comprising periodically updating the time fence positions based on data provided since a last update time.

13. The method of claim 9 further comprising updating the time fence positions in response to receipt of relevant data provided since a last update time.

14. The method of claim 9 further comprising updating the time fence positions in response to a user request.

15. The method of claim 9 further comprising designating traveling users to be notified upon entering the time fence.

16. The method of claim 9 further comprising designating traveling users to be notified upon leaving the time fence.

17. The method of claim 9 further comprising designating traveling users to be notified upon reaching the center of the time fence.

18. The method of claim 9 further comprising receiving from the generating user an indication of peer users to have access to the time fence positions and to be notified in response to crossing the time fence.

19. An travel time prediction system comprising:
a network server system adapted for communicating with one or more mobile clients application devices;
a geo-location server interface software module running on the network server system and adapted for interfacing with a geo-location server for obtaining mobile client application device location; and
a time prediction server interface software module running on the network server system and adapted for interfacing with a time prediction server for obtaining travel time prediction calculations.

20. An travel time prediction system comprising:
a network server system adapted for communicating with one or more mobile clients application devices;
a geo-location server interface software module running on the network server system and adapted for interfacing with, a geo-location server for obtaining mobile client application device location; and
a travel time prediction software module running on the network server system containing instructions for calculating time prediction based on historical route information.

21. The system of claim 19 in which the travel time prediction software module contains instructions for weighing the historical route information based on characteristics thereof.
